(19) United States
(12) Patent Application Publication
(10) Pub. No.: US 2018/0283055 A1
(43) Pub. Date: Oct. 4, 2018

(54) A LOCK HEAD

(71) Applicant: HEWLETT-PACKARD DEVELOPMENT COMPANY, L.P., Houston, TX (US)

(72) Inventor: Hsin-Ming Chen, Taipei (TW)

(73) Assignee: HEWLETT-PACKARD DEVELOPMENT COMPANY, L.P., Houston, TX (US)

(21) Appl. No.: 15/764,946

(22) PCT Filed: Sep. 30, 2015
(86) PCT No.: PCT/US2015/053303

§ 371 Date: Mar. 30, 2018

(51) Int. Cl. E05B 73/00; E05B 17/20; E05B 15/14

(52) U.S. Cl. CPC E05B 73/0082; E05B 73/0005; E05B 17/22; E05B 15/14; E05B 17/2015

(57) ABSTRACT

A lock head includes a first end with an engagement element and a second end opposite the engagement element, the first end of the lock head transitions between a first and second configuration, the first configuration allows positioning of the engagement element and the second configuration secures the first end using the engagement element.

### BACKGROUND

A lock is a mechanical or electrical fastening mechanism that is used to secure devices to prevent theft. A lock may be a warded lock, a pin-tumbler lock, a wafer-tumbler lock, a disk tumbler lock, a tubular lock, a lever tumbler lock, or a combination lock. The device that may be secured by the lock may include a laptop, a tablet, a phone, or another device. Further, a key, a combination, or biometrics of an individual may be used to unlock the lock from the device.

### BRIEF DESCRIPTION OF THE DRAWINGS

The accompanying drawings illustrate various examples of the principles described herein and are a part of the specification. The examples do not limit the scope of the claims.

FIG. 1 is a diagram of a lock head with an engagement element shown in both a first configuration on the left side of the diagram and a second configuration on the right side of the diagram, according to one example of principles described herein

FIG. 2A is a diagram of a lock head with a T-bar engagement element in a first configuration, according to one example of principles described herein.

FIG. 2B is a diagram of a lock head with a T-bar engagement element in a second configuration, according to one example of principles described herein.

FIG. 2C is a diagram of a lock head with a scissor engagement element in a first configuration, according to one example of principles described herein.

FIG. 2D is a diagram of a lock head with a scissor engagement element in a second configuration, according to one example of principles described herein.

FIG. 2E is a diagram of a lock head with a clamp engagement element in a first configuration, according to one example of principles described herein.

FIG. 2F is a diagram of a lock head with a clamp engagement element in a second configuration, according to one example of principles described herein.

FIG. 3 is a diagram of a lock head and a lock body, according to one example of principles described herein.

FIG. 4 is a diagram of a lock head and a lock body with a cable, according to one example of principles described herein.

FIG. 5 is a flowchart a method for locking a device with a lock head, according to one example of principles described herein.

Throughout the drawings, identical reference numbers designate similar, but not necessarily identical, elements.

### DETAILED DESCRIPTION

Devices such as laptops, tablets, phones, or other devices may include a variety of anchor points and/or lock ports with differing geometries. The anchor points and/or lock ports allow a user to physically lock the device via a lock or a lock system. Due to the differing geometries of the anchor points and/or lock ports, a user needs a lock or a lock system that is compatible with the anchor points and/or lock ports for the device. In turn, the user may need several different locks or lock systems for each device if the user has more than one device. As a result, the user needs a separate key or combination for each lock or lock system to be able to unlock each device.

Further, the useable life of the lock or lock system may be significantly longer than the lifetime of the device. This may result in the lock or lock system being discarded when the device becomes obsolete, damaged, or replaced.

The principles described herein include a lock head. The lock head includes a first end with an engagement element and a second end opposite the engagement element, wherein the first end of the lock head transitions between a first and second configuration, wherein the first configuration allows positioning of the engagement element and the second configuration secures the first end using the engagement element. The lock head may be replaceable and includes an engagement element that engages to a particular anchor point design of a device. For example, when the device with that anchor point design is retired, a new lock head can be obtained that fits a new anchor point design for the new device. This allows the same lock body, key, and cable of the lock system to be used with the new lock head and new anchor point of the new device. Alternately, if the user owns multiple devices, the user may opt to have a set of lock heads to allow securement of any device using a single lock body. This allows a relatively small and portable lock head with a comparable engagement element to be carried for each device, without the need to have a complete lock system for each device. Instead, the key, cable, lock body, and other parts of the lock can be used with a variety of different devices by changing out the lock head. The smaller size of the lock head, in comparison to the overall lock system allows multiple lock heads to be transported or stored more easily.

In the present specification and in the appended claims, the term “anchor point” means a portion of a device that an engagement element attaches to. Examples include lock ports, loops, rods, holes, and similar mechanical features. Anchor points come in a wide variety of designs, including proprietary designs.

In the present specification and in the appended claims, the term “lock head” means a mechanical component with a first end that connects to an anchor point and a second end that connects to a lock body. The first end includes an engagement element. The first end of the lock head transitions between a first configuration where the engagement element can be removably attached to an anchor location and a second configuration where the engagement element is secured to an anchor location.

In the present specification and in the appended claims, the term “engagement element” means a component of a lock head that secures the lock head to a device or a similar object. Examples of an engagement element include a T-bar engagement element and bumper washer, a scissor engagement element, and a clamp engagement element.

In the present specification and in the appended claims, the term “attachment feature” means a mechanical feature on the second end of a lock head that facilitates attachment and/or securement of the lock head to a lock body.

In the present specification and in the appended claims, the term “first configuration of the first end of the lock head” means a configuration in which an engagement element may be attached or removed from a suitable anchor point.

In the present specification and in the appended claims, the term “second configuration of the first end of the lock head” means a configuration where a lock head is secured to an anchor point and cannot be removed without transitioning back to the first configuration of the first end of the lock head.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

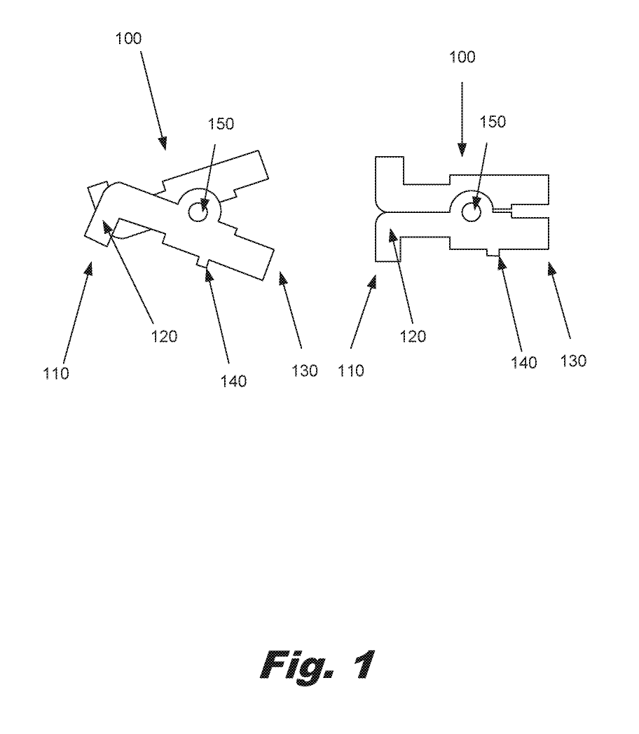

Now referring to the figures, FIG. 1 is a diagram of a lock head with an engagement element shown in both a first configuration on the left side of the diagram and a second configuration on the right side of the diagram, according to one example of principles described herein. As will be described below, the diagram includes a lock head (100) with a first end (110) and a second end (130).

As illustrated, the diagram includes two views of a lock head (100). The lock head (100) may be a mechanical component with a first end (110) and a second end (130). In an example, the lock head (100) can be made of any suitable material. Considerations such as cost, strength, corrosion resistance, aesthetic considerations, compatibility with coating or surface treatments, among other considerations may be relevant to material selection. In one example, the lock head (100) is formed from steel. In another example, the lock head (100) is formed from other potential materials including refractory metals such as aluminum or titanium. Further, polymers, including mechanical polymers such as polyether ether ketone (PEEK), polyurethanes (PU), polycarbonate (PC), and polyimide (PI) may be used to form the lock head (100). Because ceramics generally lack the appropriate impact toughness but may be appropriate in specialized situations or in use with other materials with high toughness, the lock head (100) may or may not be formed from ceramics. Composites, such as fiber reinforced polymer, may be used in some applications to form the lock head (100).

In some examples, the entire lock head (100) may be formed from a single material. Alternately, different parts of the lock head (100) may be formed from different materials or alloys. For example, a hinge (150) in a lock head (100) may be formed from a 300 series stainless steel and the remainder of the lock head (100) may be formed from polyurethane. In one example, metal components are used to provide resistance to cutting or destruction of the lock head (100) while an overmolded polymer provides features for securing the lock head (100) to a lock body, this allows complex geometries with minimal production costs. This may allow the use of a less corrosion resistant metal composition due to the environmental protection afforded by the polymer overmolding.

As illustrated, the lock head (100) includes a first end (110) with an engagement element (120). As will be described below, the first end (110) of the lock head (100) transitions between a first configuration where the engagement element (120) can be removably attached to an anchor point and a second configuration where the engagement element (120) is secured to an anchor point. As a result, the engagement element (120) enables attachment of the lock head (100) to the anchor point or lock port of a device or similar object to protected using the lock. In an example, the engagement element (120) can include a variety of different types, for example, T-bar engagement element, scissor engagement element, and clamp engagement element. The engagement element (120) may be designed to be compatible with a proprietary anchor point. Anchor points include a variety of geometries, for example, some are slots of a given dimensions, e.g., 3 millimeters (mm) by 7 mm. Some anchor points are wedges. Some anchor points are hollows and/or lock ports. Further, some anchor points are rods, recesses, bars, eyelets, or any of a wide variety of geometries. A number of different standards for anchor points and/or lock ports exist, some of which are proprietary to given manufacturers. Examples of such standards include: Kensington Security Slot, Kensington Mini Security Slot, and Noble Wedge Slot. As a result, the engagement element (120) may be customized to attach to a particular type of anchor point or port.

The engagement element (120) may be designed to work with new lock ports. The lock head (100) retains compatibility with the lock body and associated equipment, such as the cable and/or key, reducing time to market and avoiding waste by allowing new uses for the existing components. In FIG. 1, the engagement element (120) is a scissors engagement element (120-2).

In an example, the first end (110) can transition between a first configuration shown on the left side of the diagram and a second configuration shown on the right side of the diagram. In a first configuration, the engagement element (120) is situated so as to be able be positioned for locking. For example, the two blade of the scissors engagement element (120) may be close together, allowing them to pass into a lock port as illustrated on the left side of the diagram.

In a second configuration, a second end (130) is compatible with the geometry of a lock body. In a first position, the second end (130) may be compatible or, alternately, incompatible with the lock body. Similarly, the lock body may be able to attach when an engagement element (120) is not engaged, for instance, for the purpose of storage. Alternately, the lock body may attach when the engagement element (120) is firmly engaged so as to assure that the engagement element (120) is securely in place before locking the lock body.

In the second configuration, the engagement element (120) secures the lock head (100), for example, to a lock port or an anchor point. For example, with a scissor engagement element (120) element such as shown in FIG. 1, the blades may be separated so that they cannot be removed through a narrow opening. This secures the lock head to an anchor point, or lock port.

In an example, the second end (130) of the lock head (100) also has two configurations. In a first configuration, it is reversibly attachable to the lock body. In the second configuration, the second end (130) of the lock head (100) may or may not be compatible with the lock body. The second end (130) of the lock head (100) may include a wide variety of attachment features (140) to facilitate attachment and/or securement of a lock body into the lock head (100). The attachment features (140) may include protrusions, cuts, slots, ridges, holes, or tapers.

The lock head (100) may include a hinge (150). The hinge (150) may facilitate a transition between the first and second configurations of the first end (110) and the second end (130). For example, the hinge (150) may allow motion of the lock head (100) similar to a pair of scissors, a pair of pliers, and/or similar tools that transition between open and closed or locked and unlocked. In some examples, the hinge (150) is large compared with a width of the lock head (100). This may help strengthen the lock head (100) to avoid breakage or resist the application of force. In one example, the hinge (150) is greater than half the local width of the lock head (100).

In other examples, the lock head (100) transitions between the first and second configurations using non-hinge movement. Examples include sliders, joints, spindles, ball-in-socket joints, and knuckle joints.

The lock head (100) may be designed such that both the first end (110) and the second end (130) are open at the same time or both the first end (110) and the second end (130) are closed at the same time, similar to a pair of scissors. Alternately, the lock head (100) can be designed such that when one end is open, the other end is closed. For example, when the first end (110) is opened, the second end (130) is closed. In another example, the second end (130) does not need to open or close in order for the lock head (100) to function. For instance, the second end (130) may include a slider and/or another mechanism that is coupled to the actuation of the engagement element (120).

As illustrated, the lock head (100) includes attachment features (140). The attachment features (140) may be located on the second end (130) of the lock head (100) to facilitate attachment of the lock head (100) to a lock body. In FIG. 1, the attachment features (140) include a bump on an outside edge of the second end (130) of the lock body. Other figures show other examples of other attachment features.

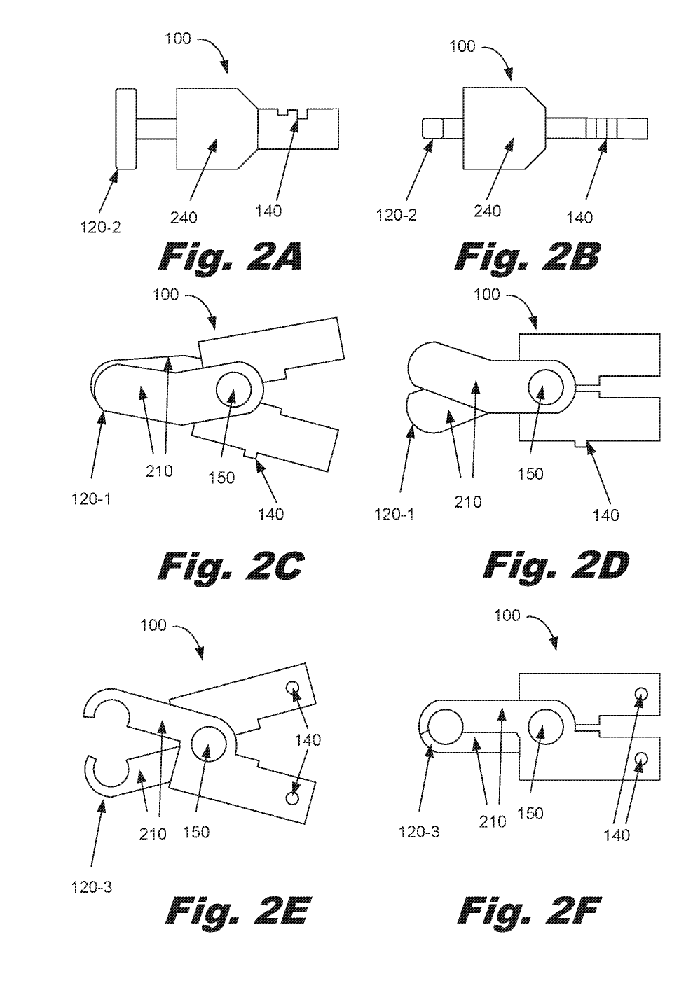

FIGS. 2A to 2F illustrate several examples of lock heads (100) in both a first and second configurations. Further, FIGS. 2A to 2F illustrate different engagement elements for the lock heads.

FIG. 2A is a diagram of a lock head with a T-bar engagement element in a first configuration, according to one example of principles described herein. As will be described below, in this configuration the T portion of the T-bar engagement element can pass through a lock port on a device and rotate so as to be unable to pass directly out of the lock port on the device. In many cases, the T-bar engagement element is rotated so the T-bar engagement element is rotated 90 degrees to the slot. FIG. 2A also shows a bumper washer that provides a force on the outside of the lock port. As a result, the T-bar engagement element and the bumper washer trap the sides of the lock port between them, holding the T-bar engagement element in place. Further, the lock head many also include attachment features on the second end of the lock head that facilitate securement of a lock body to the lock head.

As illustrated, the lock head (100) includes a T-bar engagement element (120-2). A T-bar engagement element (120-2) has a T-like feature that is able to rotate and compress to hold a portion of the anchor point or lock port between the two arms of the T part of the T-bar engagement element (120-2) and a surface surrounding the shaft of the T-bar engagement element (120-2). The T-bar engagement element (120-2) may pass through a lock port that shares a profile of the T-bar engagement element (120-2). The T-bar engagement element (120-2) may then rotate behind the opening before locking in place. As the axis of rotation and the axis of engagement are different, the T-bar engagement element (120-2) can have very high securement strength. In one example, the T-bar engagement element (120-2) is accommodated in a slot, pins, or similar feature on the device that inhibits rotation of the T-bar. Such a feature may be at 90 degrees to the lock port that the T-bar engagement element (120-2) passes through.

FIG. 2A also illustrates attachment features (140). The attachment features (140) facilitate connection of the lock head (100) to a lock body and/or securement to the lock body. In FIGS. 2A and 2B the attachment features (140) are key like.

FIG. 2B is a diagram of a lock head with a T-bar engagement element in a second configuration, according to one example of principles described herein. As will be described below, the T-bar engagement element is shown in an engaged position.

As illustrated, the T-bar engagement element (120-2) of FIG. 2B has rotated compared to the T-bar engagement element (120-2) of FIG. 2A. Due to this rotation, the T-bar engagement element (120-2) of FIG. 2B has moved closer to the center portion of the lock head (100) so that the gap between the T-bar engagement element (120-2) of FIG. 2B and the bumper washer (240) is smaller.

In an example, when the T-bar engagement element (120-2) is engaged as illustrated in FIG. 2B, the T-bar engagement element (120-2) holds the lock head (100) securely again a lock port The lock head (100) may have a bumper washer (240) that resiliently accommodates compression of the T-bar engagement element (120-2) towards the body of the lock head (100).

FIG. 2C is a diagram of a lock head with a scissor engagement element in a first configuration, according to one example of principles described herein. As will be described below, this version of the lock head includes a scissors style engagement element. A scissors engagement element is designed to pass through a lock port of a device and then expand so as to be unremovable until it is returned to the first configuration.

As illustrated, the blades (210) of the scissor engagement element (120-1) are in close proximity to allow them to pass through a small, narrow, or otherwise constrained opening of a lock port of a device. While two blades (210) are illustrated, a scissor engagement element (120-1) may alternately have three or more blades. The blades (210) may be straight or bend as shown in FIG. 2C and FIG. 2D respectively. The blades (210) may have a smooth edge or may have bumps, notches, or similar features to enhance the securement of the lock head (100) to an anchor point.

The second end (130) of the lock head (100) may have attachment features (140) to help attach or secure the lock head (100) to a lock body. In FIG. 2C, the attachment features include a bump on the outside edge of the second end (130) of the lock head (100).

FIG. 2D is a diagram of a lock head with a scissor engagement element in a second configuration, according to one example of principles described herein. As will be described below, this figure depicts a lock head with a scissor engagement element in a second configuration, such that the scissor engagement element cannot pass through a lock port without first being transitioned to the first configuration

In FIG. 2D, the blades (210) of the scissor engagement element (120-1) are separated so as to enlarge a dimension of the scissor engagement element (120-1). This prevents the blades (210) from passing through an opening or narrow space of a lock port and/or anchor point of a device. In some examples, the blades (210) of the scissor engagement element (120-1) may press against the sides of a lock port of a device. In other examples, the blades (210) may have significant freedom of motion but are unable to pass through the lock port of the device.

FIG. 2E is a diagram of a lock head with a clamp engagement element in a first configuration, according to one example of principles described herein. As will be described below, as shown in FIG. 2E, the clamp engagement element may be moved around an anchor point, rod, or similar element. The clamp engagement element is then transitioned to the second configuration as shown in FIG. 2F clamping the clamp engagement element into place.

A clamp engagement element (120-3) passes on either side of a rod, bar, or similar anchor point in the first configuration. The opening of the clamp engagement element (120-3) allows passage to the anchor point of a device such that the clamp engagement element (120-3) will attach to the anchor point when the engagement element clamp (120-3) transitions to the second configuration.

The clamp engagement element (120-3) includes attachment features (140) located on the second end (130) of the lock head (100). In FIGS. 2E and 2F, the attachment features are holes. In one example the second end (130) of the lock head (100) slides into a lock body and then rotates. The holes of the attachment feature (140) mate with pins in the lock body and enhance the securement between the lock head (100) and the lock body.

FIG. 2F is a diagram of a lock head with a clamp engagement element in a second configuration, according to one example of principles described herein. As will be described below, the clamp engagement element transitions to a second configuration.

In the second configuration, the two blades (210) of the clamp engagement element (120-3) are brought closer together so as to reduce the gap between them. The blades (210) may be brought into contact or they may keep a gap between them that is smaller than a bar or rod they are secured to. The blades (210) may also slide past each other so that the distal portion of the clamp engagement element (120-3) has material from both blade (210) resisting removal. The clamp engagement element (120-3) may be sized to rigidly attach to a bar or similar anchor point. Alternately, the clamp engagement element (120-3) may be sized to hang onto a bar or similar anchor point while maintaining significant freedom of motion.

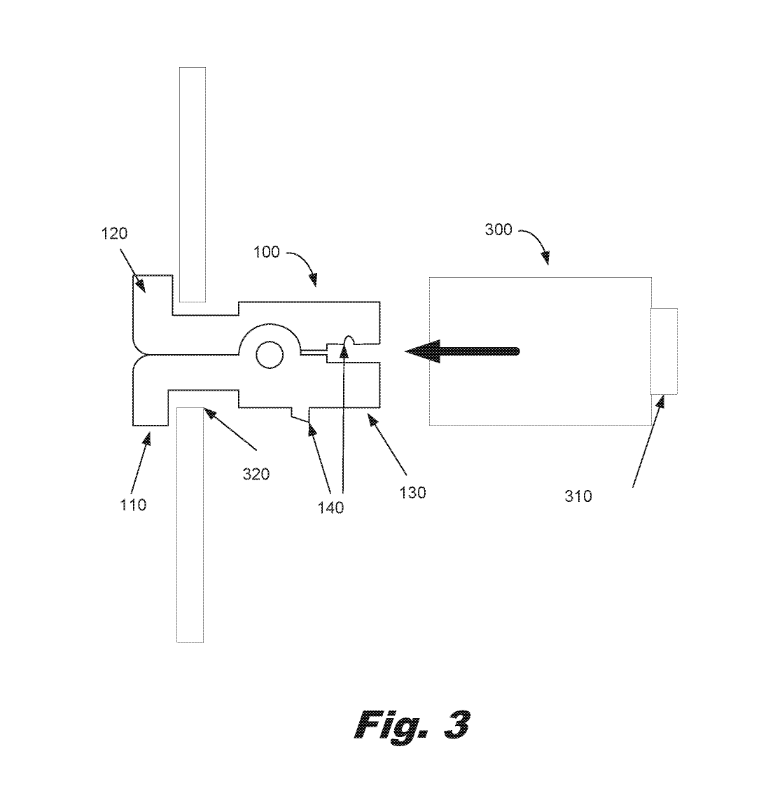

FIG. 3 is a diagram of a lock head and a lock body, according to one example of principles described herein. As will be described below, the lock body attaches to the second end of the lock head and prevents the first end of the lock head from transitioning to the first configuration.

As mentioned above, the lock body (300) attaches to the lock head (100) when the engagement element of the lock head (100) is secured. The lock body (300) may attach along a different axis than is used by the engagement element so as to reduce a malefactor's ability to apply force against the engagement element of the lock head (100). For example, the engagement element may open and close around a pivot while the lock body (300) attaches by sliding over the lock head (100) and rotating. The second end (130) of the lock head (100) may include attachment features (140) such as nubs, ridges, bumps, holes, slots, or other attachments features to guide and/or secure the attachment of the lock body (300). In one example, the attachments features are beveled to facilitate rotation of the lock body (300) relative to the lock head (100). The lock body (300) may include a one-way latch or similar non-reversible element that allows the lock body (300) to attach to the lock head (100) but prevents removal without unlocking the lock body (300). Alternately, the lock body (300) may only be lockable by using a key to prevent a user from unintentionally locking the device, for example, to a physical object when they don't have the key available.

As illustrated, the first end (110) of the lock head (100) is secured to a lock port (320). The lock head (100) has a second end (130) that connects with the lock body (300) such that the lock head (100) is unable to change configuration while attached to the lock body (300). The second end (130) may include features (140) to facilitate this attachment. Such features may be on the inside and/or outside edges of the second end (130) of the lock head (100). Alternately, the features (140) may be in the body of the second end (130) of the lock head (100). The lock body (300) may be secured to the lock head (100) using a lock (310), or other mechanical feature.

In one example, the lock head (100) slides into the lock body (300) and then rotates into position before being secured. The engagement between the lock head (100) and the lock body (300) may be along a single axis of motion. In other examples, the engagement between the lock head (100) and lock body (300) may include multiple axes of motion. It may be preferable to have an one axes of motion involved in the engagement of the lock head (100) and lock body (300) be different than the axis of motion that changes the configuration of the lock head (100) so as to reduce the ability of a malefactor to apply force to the engagement element (120) through the lock body (300).

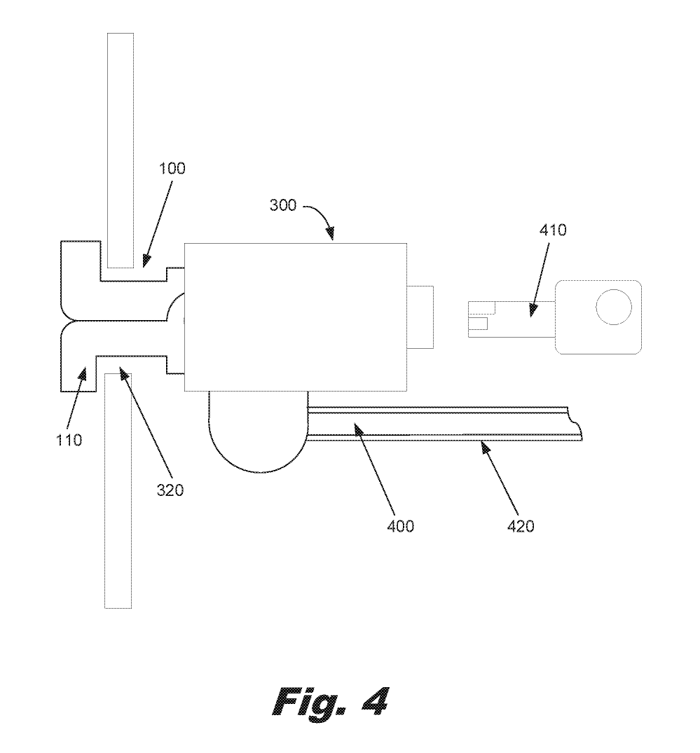

FIG. 4 is a diagram of a lock head and a lock body with a cable, according to one example of principles described herein. As will be described below, a key may be inserted into a lock body to unlock the lock body, allowing the lock body to separate from the lock head. This allows the lock head to be removed from an anchor point of a device.

As illustrated, the diagram includes a cable (400). The cable (400) may be any appropriate configuration of cable, chain, filament, fiber, etc. In one example, the cable (400) is a wound cable covered with a polymer jacket (420), e.g. polyvinyl chloride (PVC). Another example is a chain with a polymer jacket. A third example, is a braided assembly. The cable (400) can be of any reasonable length. In one example, the cable is between 0.5 and 1.5 meters. In one example the cable (400) is approximately 1.2 meters (between 1.1 to 1.3 meters). One end of the cable (400) may be formed into a loop. The cable (400) may be spliced, welded or otherwise modified to form the loop on the end. The loop facilitates forming a clove hitch-like knot around an object by threading the free end of the cable through the loop. This facilitates securement of the lock to an immobile or secure feature.

The cable (400) can be attached to the lock body (300) by a variety of technologies such as crimping, swaging, etc. In some examples, the cable includes a polymer jacket (420) that protects the cable from damage and/or damaging softer materials. The cable (400) may be fixed to the lock body (300). Alternately, the cable (400) may be removable from the lock body (300) when the lock body (300) is not attached to the lock head (100). For example, the cable (400) may be able to pass through a slot in the lock body (300) when the lock body (300) is not engaged. However, when the lock body (300) is engaged, a crimped or swaged element on a proximal end of the cable (400) may be secured against the lock body (300).

In an example, any suitable mechanism could be used to secure the lock body (300) in place relative to the lock head (100). In one example, a key-based lock may provide some advantages. The use of both flat keys and circular keys (tubular lock) can be accommodated depending on the specific design and geometry chosen. In this example, the key (410) may be a straight or tubular key. The key (410) may be used to lock and unlock the lock body (300). Alternately, the key (410) may only be needed to unlock the lock body (300). The key (410) may enter the lock body (300) along an axis parallel to the length of the lock head (300). The key (410) may include an identifier that indicates the associated lock body (300). Such an identifier may include a logo, color pattern, symbol, or characters including text. A similar or identical identifier may be included on the lock body (300).

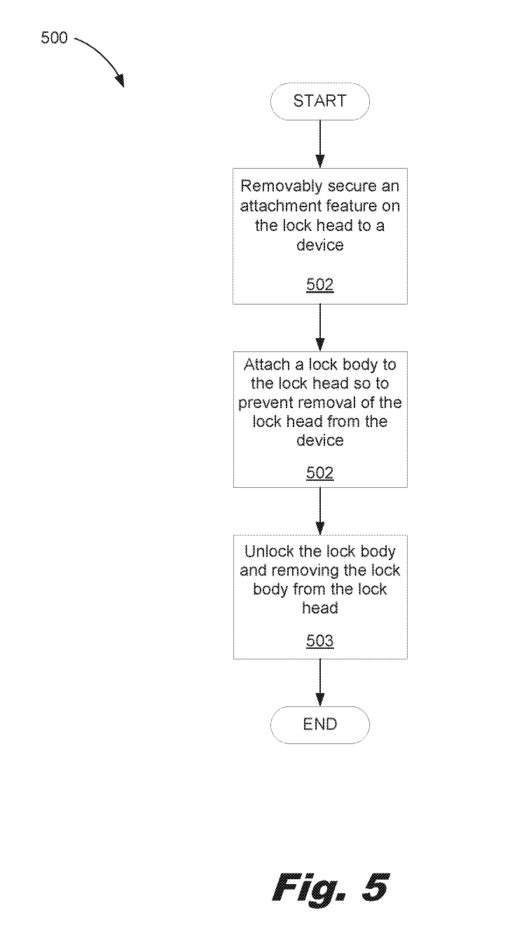

FIG. 5 is a flowchart a method for locking a device with a lock head, according to one example of principles described herein. In an example, the method (500) includes removably securing (501) an attachment feature on the lock head to a device, attaching (502) a lock body to the lock head so to prevent removal of the lock head from the device, and unlocking (503) the lock body and removing the lock body from the lock head.

As mentioned above, the method (500) includes removably securing (501) an engagement element (120) on the lock head (100). This allows the lock head (100) to be secured to a device or similar object to be protected by the lock on the lock body (300). At this point the lock head (100) can be removed by a person without opening the lock on the lock body (300). Similarly, the engagement element (120) of the first end (110) of the lock head (100) can be freely attached and removed from an object to be secured. For example, the lock head (100) may be secured to a lock port of a laptop. In another example, the lock head (100) may be secured to an anchor point of a cellphone. In a third example, the lock head (100) may be secured to an anchor point on portable drive. Prior to securing the engagement element, a cable (400) and/or a suitable part of the lock body (300) may be attached to a large, immobile object such as a desk, a pillar, a workbench, a bicycle rack, a metal frame, or other object.

As mentioned above, the method (500) includes attaching (502) a lock body (300) to the lock head (100) so to prevent removal of the lock head (100) from the device. By securing a lock body (300) to the lock head (100), the lock body (300) prevents the lock head (100) from being detached from a secured device without removing the lock body (300). Specifically, the lock body inhibits the first end (110) of the lock head (100) from transitioning between the two configurations. This in turn, keeps the engagement element (120) securing the lock head (100) to the protected object.

As mentioned above, the method (500) includes unlocking (503) the lock body (300) and removing the lock body (300) from the lock head (100). Removing the lock body (300) from the lock head (100) allows the first end (110) of the lock head (100) to transition from the second configuration to the first configuration, which in turn allows the engagement element (120) to disengage from the device and allows the lock head (100) to be separated from the device.

The preceding description has been presented to illustrate and describe examples of the principles described. This description is not intended to be exhaustive or to limit these principles to any precise form disclosed. Many modifications and variations are possible in light of the above teaching.

What is claimed is:

1. A lock head, comprising:
a first end with an engagement element; and
a second end opposite the engagement element, wherein the first end of the lock head transitions between a first and second configuration, wherein the first configuration allows positioning of the engagement element and the second configuration secures the first end using the engagement element.

2. The lock head of claim 1, wherein the engagement element is selected from a T-bar, a scissor, and a clamp.

3. The lock head of claim 1, further comprising an attachment feature on the second end.

4. A system, comprising:
a lock head, comprising:
an engagement element located on a first end of the lock head; and
a connecting portion located on a second end of the lock head, the first and second ends of the lock head being opposite each other, wherein the lock head can transition between two configurations:
a first configuration intended to position the engagement element with respect to an anchor point;
a second configuration intended to fix the engagement element to the anchor point; and
a lock body, the lock body having two configurations:
a first configuration wherein the lock body removably attaches to the connecting portion of the lock head; and
a second configuration wherein the lock body is irremovably secured to the lock head.

5. The system of claim 4, wherein the lock body further comprises a cable with a loop on a distal end of the cable.

6. The system of claim 4, wherein the engagement element on the first end of the lock head is a T-bar.

7. The system of claim 4, wherein the engagement element on the first end of the lock head is a scissor.

8. The system of claim 4, wherein the engagement element on the first end of the lock head is a clamp.

9. The system of claim 4, further comprising a plurality of lock heads with different engagement elements and a common geometry of the connecting portion such that any of the plurality of lock heads can be used with the lock body.

10. The system of claim 7, wherein the scissor is compatible with a 3 millimeter (mm) by 7 mm opening.

11. The system of claim 7, wherein the scissor is compatible with a wedge shaped opening.

12. The system of claim 4, wherein the lock head comprises a hinge joint and a motion of the hinge joint accompanies transition between the first and second configurations of the lock head.

13. The system of claim 4, wherein the lock head is smaller in a dimension in the first configuration and the lock head is larger in the same dimension in the second configuration, such that the lock head can be removed from the anchor point when in the first configuration but not when in the second configuration.

14. The system of claim 4, wherein the lock body transitions between the first and second configuration using a key.

15. A method, comprising:
removably securing an attachment feature on a lock head to a device;
attaching a lock body to the lock head so to prevent removal of the lock head from the device; and
unlocking the lock body and removing the lock body from the lock head.
